(19) United States
(12) Patent Application Publication
(10) Pub. No.: US 2015/0099500 A1
(43) Pub. Date: Apr. 9, 2015

(54) VEHICLE OPERATOR/DRIVER AND WIRELESS DEVICE SYNCHRONIZATION AND USES THEREOF

(71) Applicant: William Chalmers, Gilbert, AZ (US)

(72) Inventor: William Chalmers, Gilbert, AZ (US)

(21) Appl. No.: 14/047,757

(22) Filed: Oct. 7, 2013

(51) Int. Cl. H04W 48/04

(52) U.S. Cl. CPC H04W 48/04
USPC 455/418

(57) ABSTRACT

A vehicle operator/driver and device synchronization application is disclosed herein and includes: a two-way communication device, a software application stored on and executed from the device, from a network or a combination thereof, a vehicle communication component, a velocity determination component, and a driver identification component.

### FIELD OF THE SUBJECT MATTER

The field of the subject matter is the synchronization of a vehicle driver or operator, any number of passengers and the wireless device or devices in the vehicle, including methods of operation and uses thereof.

### BACKGROUND

Cell phone technology has evolved from large expensive devices that only the very wealthy could afford and only simply made phone calls from a moving vehicle to small, inexpensive devices that can not only make phone calls but can allow you to surf the web, text, find your favorite restaurant chain and even play games. These new devices are called smart phones, simply because they can do so many different and valuable activities.

These smart phones generally make life easier, help us to stay connected with our friends and family, and make our daily lives more efficient. The unexpected behavior of being so connected with our friends and families is that we feel we must stay engaged with every instant message thread, and reply to every email right away or reply to every text sent to us. Texting, which is a hybrid between an E-mail and a phone call, has become a major distraction while we drive our cars. It combines the danger of being distracted from the driver's surroundings with typing on the device. As a matter of fact, there have been many studies comparing texting while driving to drunk driving. Some studies actually show that texting can slow our reflexes even more the drunk driving.

Despite the fact that many states have made the use of hand held devices, including cell phones while driving illegal, data shows that more and more drivers are using their phones. Studies have been done showing the continued use of handheld and drivers admit to using their phones while driving. In some states these laws are established as a primary enforcement, meaning police officers only need to see someone using their phone while driving to pull them over and site the driver.

Companies who provide smart phones or hand held devices to employees are constantly reminding their employees not to use the devices while driving, including putting formal policies in place to address using these devices while driving. However, the most alarming statistic around texting and driving is how many young adults are killed simply because they could not resist the temptation to text or review a reply to a text message or E-mail. The majority of parents who have lost their children to texting and driving have said that they had rules or agreements with their children to not text and drive but parents have no way to know if their child is violating their rules.

As smart phone technology advances, there are opportunities to address texting and driving or operating a vehicle as part of the device. However, power and battery life issues must always be considered. Manufactures require that their suppliers provide them with components that are smaller in size, consume less power and can be put into a low power state. Manufacturers of these phones rely on three technologies to overcome the increased demand in power: a) improved and more sophisticated batteries, b) power saving modes within the processor, and c) real-time information to the consumer related to power consumption.

The single most important element to creating a solution to keep drivers from texting while driving is to determine if the phone is moving at a rate that indicates the phone is in or on a vehicle. One method of addressing texting and driving involves tracking the phone in use by using global positioning satellite technology or GPS technology. Almost all cell phones contain GPS units that can easily determine speed, but GPS consumes power, requires a clear line of sight, and in cloudy areas or within a vehicle getting a clear signal may take several minutes or no signal may be established at all.

Another method of addressing texting and driving involves tracking the phone in use by triangulation between cellular towers and WIFI networks. Triangulation using WIFI networks is actually not very practical because of the inconsistency of WIFI networks during travel and the current limitations on the distance WIFI signals can be transmit. Another option is triangulation using cellular towers, which is much more practical, but it also has coverage issues and consumes more power than a normal cell phone call. Utilizing this method also drains the battery life of the phone in a similar fashion to leaving the phone on during plane travel. The phone's radio is constantly searching for a signal, and that searching drains the battery. This method requires the phone to establish a connection with three cell towers and constantly transmit and receive signal strength information. This additional communication consumes almost three times the power of a normal cellular call.

Any successful solution to solve these, sometimes devastating, problems must generally not be obtrusive to the user of the phone or device, while at the same time useful for long distances, while not significantly reducing the battery life of the device. Said another way, the user shouldn't know the application is there until the user gets into a car. Once that user gets into the car, the application must be extremely easy to use and quickly begin operation. No user wants to get into their car and then wait on their phone to tell them it is okay to drive.

Once the vehicle is started and underway, any successful solution needs to quickly determine the vehicle, the devices, velocity, speed or a combination thereof. Speed is the most important piece of data as it will allow for any successful solution to determine what policy the parent or owner of the vehicle wants to see happen.

To this end, it would be desirable to develop, produce and utilize a vehicle operator/driver and wireless device synchronization application that meets the following goals: a) does not significantly drain the power or battery life of the device, b) is relatively easy to install, c) is relatively easy to use, d) cannot be easily removed from the device, e) can be easily upgraded as new technology is introduced, and f) does not rely solely on GPS or triangulation technologies.

A vehicle operator/driver and device synchronization application is disclosed herein and includes: a two-way communication device, a software application stored on and executed from the device, a vehicle communication component, a velocity determination component, and a driver identification component.

A vehicle operator/driver and device synchronization application is disclosed herein that includes: a two-way communication device, a software application stored on and executed from the device, a vehicle communication component, a velocity determination component, a driver identification component, and a password generation component.

### BRIEF DESCRIPTION OF THE FIGURES

FIG. 1 shows the contemplated components of a vehicle operator/driver and device synchronization application, including optional embodiments.

FIG. 2 shows the contemplated components of a non-removal component for a vehicle operator/driver and device synchronization application.

### DETAILED DESCRIPTION

A vehicle operator/driver and wireless device synchronization application has been developed and will be described herein that meets the following goals: a) does not significantly drain the power or battery life of the device, b) is relatively easy to install, c) is relatively easy to use, d) cannot be easily removed from the device, e) can be easily upgraded as new technology is introduced, and f) does not rely solely on GPS or triangulation technologies.

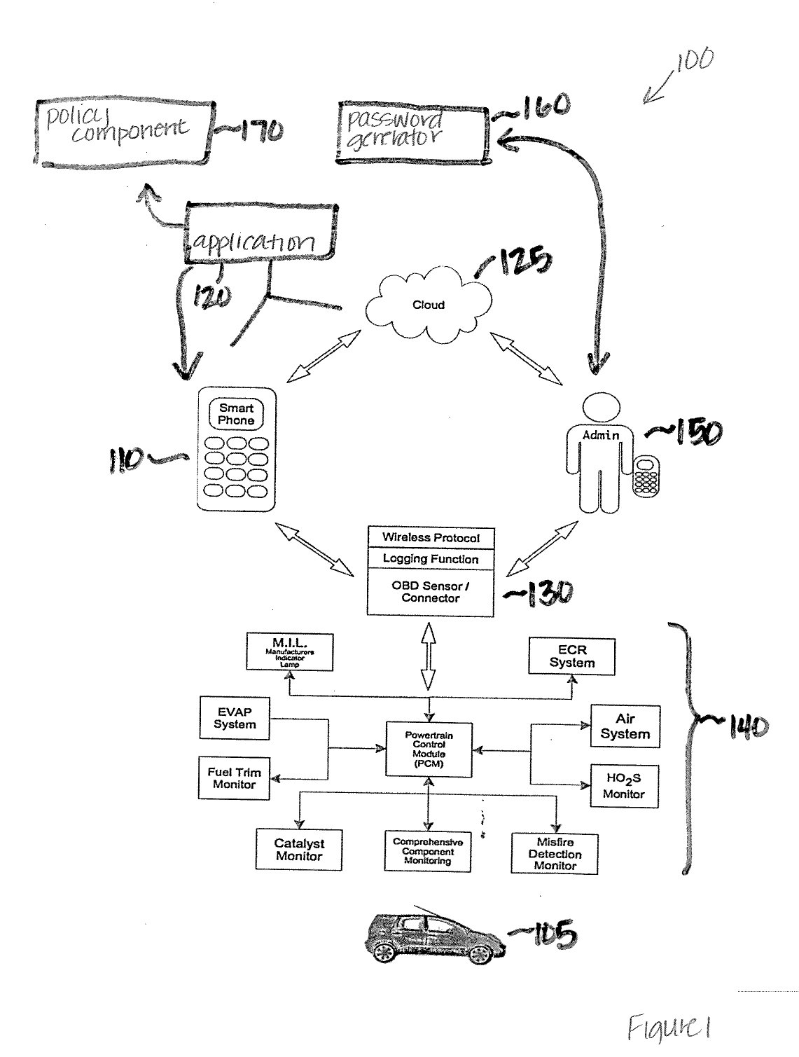

Contemplated embodiments and technologies disclosed herein are actually a collection or amalgam of different technologies designed to solve the problem of texting and driving. Specifically, and as shown in FIG. 1, a vehicle 105 operator/driver and device synchronization application system 100 comprises: a) a two-way communication device 110, b) a software application 120 stored on and/or executed from the device 110 or from a network, such as the cloud 125, c) a vehicle communication component 130, d) a velocity determination component 140, and e) a driver identification component 150. As will be described herein, contemplated embodiments also comprise a password generator 160 and a policy component 170.

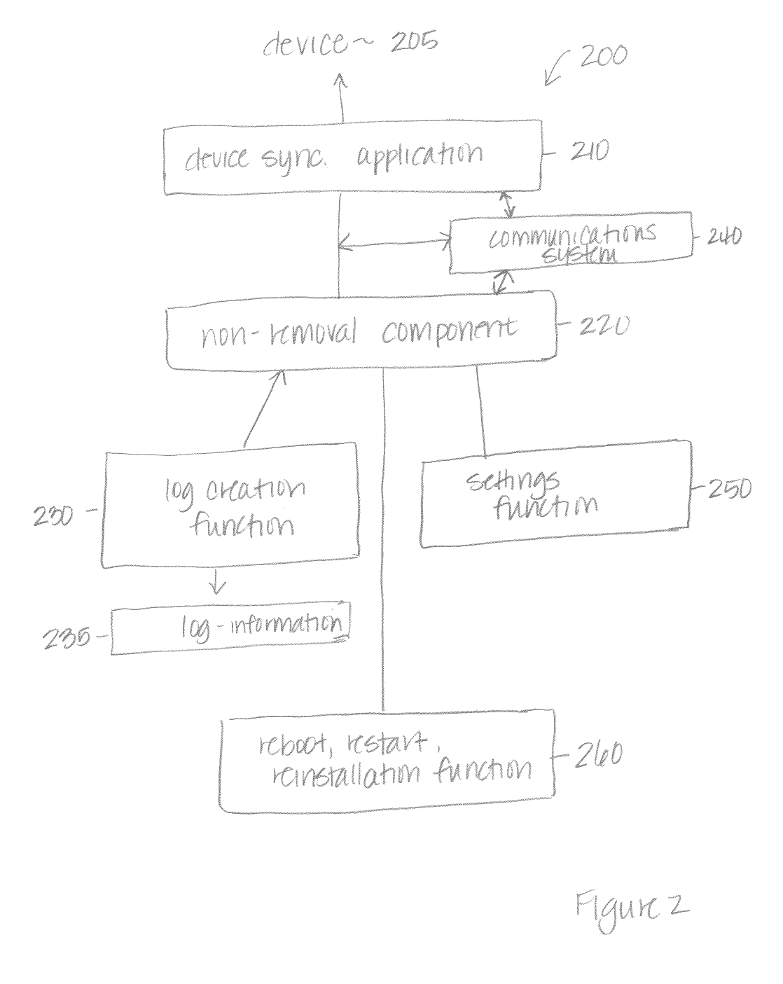

In some embodiments, contemplated synchronization applications comprise a non-removal component, as will be described herein and as shown in FIG. 2. It should be understood that “device” or “hand held device” refers to any device that allows for two way communication, wireless communication and can easily be used in a vehicle. Contemplated embodiments also include mobile wireless routers that are designed specifically for use in vehicles, such as those made by Autonet Mobile.

A contemplated velocity determination component determines in real-time the velocity of the vehicle, the velocity of the device or a combination thereof. In one embodiment, accelerometers and gyroscopes and various signal processing algorithms are used to determine velocity. Accelerometers provide acceleration data along the x, y and z axis. Gyroscopic data can be used to provide orientation of a device in relation to gravity in the x, y and z axis. By fusing the accelerometer and gyroscopic information and measuring the change in acceleration over a known period of time velocity can be calculated. Both the accelerometer and gyroscopic data stream must be run through signal processing filters such as Kalman filter or high pass filters to increase accuracy. The advantage of using accelerometers and gyros is that they consume the least amount of power when compared to GPS, WIFI and cellular. Using accelerometer and gyroscopic data to determine velocity will over time produce inaccurate results but the algorithm will easily provide enough accuracy to determine initial velocity long enough to conclude the vehicle is in motion allowing for a violation to be captured. In another contemplated embodiment, various wireless protocols are used to communicate with the vehicles on board diagnostics (OBD) to determine various data, including vehicle speed, transmission mode (park versus drive) and other data that can assist in determining if the vehicle is in motion.

The single biggest technical and functional challenge for any anti-texting application is determining who is the driver when multiple users with the same application is running on their phones and are in the vehicle together. In order to address this challenge, a driver identification component has been developed that can identify the driver, lock that driver's device and allow other devices in the vehicle to remain fully operable.

In a specific embodiment, the software application that is stored on and executed from the device must first be assigned to a specific vehicle during its initialization by the parent or administrator, in this example. Once the application is installed, each vehicle the family owns is assigned to that device by using the application and a primary driver is identified.

In the event that multiple people, who are assigned to the car, get into the car to go somewhere, the application will have a second usage model. When everyone gets into the car, all phones will detect the vehicle communication component that is installed in the car. The application will ask all users: “are you the driver or a passenger”. The driver will identify themselves to the device as the driver. Once the driver and the device have synced, the driver's phone will then follow the policy defined by the parent or supervising entity, which may include that the phone can then be used. Using NFC (Near Field Communication) or another wireless communication technology or protocol, will then be used to tell the other phones that a driver has been identified and the others are indeed passengers.

In the event that the driver does not establish themselves as the driver and the car goes into motion, everyone in the car with this solution will experience the same policy that their parents, fleet operators, employers, insurance companies and/or other supervising entities have established, which is that all devices are assumed to be the driver and the phones will have limited functionality.

In some embodiments, a non-removal component system 200 is a part of the device 205 synchronization application 210. As a matter of fact, it is important that the application can't be removed by a teenager or employee. Contemplated non-removal components 220, as shown in FIG. 2, will comprise at least one log creation function 230, at least one communication system 240, at least one dedicated settings function 250 and at least one reboot function, restart function or combination thereof 260. In yet other embodiments, contemplated log creation functions can also capture 235 information about the vehicle, including the engine status, error codes and vehicle maintenance information. In contemplated embodiments, the log creation functions are used to determine if the application has been tampered with, and to that end, provide at least one piece of reporting information. In some embodiments, the at least one piece of reporting information comprises the date of the tampering, the time of the tampering or a combination thereof.

By way of example, the device itself will log all the times, duration and miles driven when no device was paired to it, which is the log creation function. When the parent's phone comes near the car, the device will transmit this information to the parent so they can look into why the car is traveling around without a registered driver through the communication system. In other words, the combination of these various logs will allow the parent to hold the teenager or employee accountable. If the application is somehow removed from the device, a ‘failsafe’ daemon or reboot/reinstallation function will execute whatever policy (using the dedicated settings function) the parent selected for this event. The policy could be to text a message to the parents or for the phone to be ‘bricked’ until the parent resets it with their private code. As used herein, the term ‘bricked’ means that the phone will not be harmed in any way, but all of its functionality can be turned off except for emergency calls. Emergency calls may also include numbers the parents enter into the application, if the app is removed.

The daemon that remains on the phone and/or handheld device will transmit to a cloud service and log information of the vehicles usage with or without out an identified driver. The parent or supervising entity can check the online log information or when they drive the car they will be alerted with the same information stored in the cloud. If the parent selects the option to have violations communicated to them, they will be transmitted either via text or email. In the extreme event that the teenager or employee successfully removes the application these various logging functions will allow easy determination of violations so violators can be held accountable.

In some embodiments, the parents, employer or administrator may set the device up such that if the application is disabled or an attempt to disable the application is logged, the device shuts down and will not be able to be used until the parent, employer or administrator enters a reboot or restart code.

In other embodiments, a coordinated holster or holder may be provided in the vehicle that is designed to hold the device and potentially activate the synchronization application and/or communicate with any other devices in the vehicle. In some contemplated embodiments, the holster or holder assembly could also function to charge or recharge the device.

### EXAMPLES

### Example 1

### Parent or Employer Installation

An OBDII or similar device with wireless functionality is provided and should be installed in each vehicle. These devices are designed to capture the speed or velocity directly from various vehicle bus protocols and to communicate to the application on the smart phone via a wireless protocol. Typical installation locations should be within reach from the driver's seat example locations are the right or left side of the steering wheel just past end of plastic or leg airbag, center of car under the stereo or the center console.

In the future, car manufactures will adopt the OBDIII standard which will transmit OBD data via wireless protocol. This technology will naturally extend to OBDIII and future standards the car manufacturers adopt.

The parent or supervising entity will then install the software application onto one or more family devices. The parent or supervising entity will be given the option to use the handheld device to associate the OBDII device with the specific handheld device or an application on a portable computer (laptop). In the case of a fleet manager an OBDII simulator can be used pre-program the OBDII devices. The parent or employer will be asked to input the make, model and year of production of their car. The parent or supervising entity will be asked to install the OBDII bluetooth device into the OBD connector. If the device is supported then the VIN for that specific car will be downloaded and associated with that phone/user. The parent will need to repeat this sequence for each car the teenager or employee will be allowed to drive.

As mentioned, the parent or supervising entity will need to download the application from their phones supported ‘store’. Android devices will need to go to Google Play, Microsoft will go to Microsoft's application store and Apple devices will need to go to Apple's IOS app store.

Once the application has been downloaded they will need to initiate an install either by clicking ‘run’ after download or the installation itself will begin the installation process. Immediately after installation, the user will be prompted to provide a password which will be required to fully uninstall the application disabling the failsafe's to guard against unauthorized application removal. The password generation component utilizes information from the vehicle, the device or a combination of both to generate a PIN for the system. In contemplated embodiments, the system password is unique.

After the family or fleet vehicles and devices are updated, and we have associated the vehicle data, including the VIN and the specific OBDII Bluetooth low energy or LE device installed, it is time to start making some policies. The first question that the parent must answer is “what is their definition of stopped?”. Does stopped mean the vehicle has zero speed and the brake pedal is depressed, or does stopped mean that the vehicle has zero speed but the vehicle is in ‘Park’. Does the parent want to say the vehicle must be stopped for more than 0 or x seconds before it is stopped to them. The parent's definition of stopped will be used throughout the policy engine.

The parent or supervising entity will be asked a series of questions or presented with radio buttons to determine what the parent wants to happen or be notified of once the vehicle is moving. The selection of ‘no texting while in motion’ or ‘no calling while in motion’ (or both) will be presented, because a parent or supervising entity might allow their teenager or employee to call and/or text certain numbers via a hands free headset while driving. A parent might decide that it is fine if their teenager brings the vehicle to a stopped position and establishes a phone call or texts. The supervising entity or parent may also be fine with the teenager using the phone to make a call in hands-free mode while the vehicle is moving. They might allow or mandate that all calls can only be connected while the vehicle is stopped and the call allowed to continue once the vehicle is in motion provided the teenager is using a hands free headset. The policy options will allow for the parent to customize what they allow their teenager to do so they feel their teenager is safe. Employers can set policies not only to ensure safety of their employees, but also to minimize risks and/or seek discounted insurance rates.

It is going to be highly recommended that the parent or supervising entity take the phone into each car associated with that phone and let someone drive them around so that they can check to make sure that the synchronization application is following the parent's wishes/settings/policies correctly.

Once the phone has been turned over to the teenager, the user/teenager/employee can decide on ‘pre canned’ replies to be texted to their friends while they are driving. They can create a text reply saying: “I am driving to school and I should be free to text at about 8:15 am”. Or “I am on an errand that should take me about 20 mins, text you then”. They can also work with their parent to determine what are the safe calls that can be made while driving, if any.

The teenager should start the car as they normally do. Once the car has been started they simply need to tap their phone to the NFC tag installed by their parent and put their phone in a safe place.

When the teenager leaves the car all they need to do is turn off the car as they normally would and then tap the phone to the NFC tag, and their phone will immediately be put back into a full functionality mode. If they don't tap the NFC or Bluetooth tag there is a good chance for a delay as the connection to the OBDII Bluetooth device in the car times out. Once they walk past the range of Bluetooth, the phone will log that the phone disconnected abnormally from the OBDII device.

While this technology is centered around keeping drivers from texting and driving, a parent will be given the option to not allow texting during certain times of the day and specific days. The application will allow for the parent to automatically establish that any violations of the policy will result in a ‘grounded’ functionality. Obviously it will be up to the parent to determine what functionality will be restricted or eliminated while the phone is ‘grounded’.

### Example 2

### Bluetooth-Related Embodiment—Android Devices

During initialization, the synchronization application inserts itself between the default SMS (texting app), any web-surfing applications, any loaded applications, phone call send and receive applications, along with any other application that is viewed as a potential distraction, and the operating system. It should be understood that contemplated systems are designed to operate on Android devices, Apple systems, Microsoft systems, Blackberry systems and any other suitable handheld device. It should also be understood that while both NFC and Bluetooth are used throughout this document the phone industry has not settled on either a formal or defacto standard on either NFC or Bluetooth 4.0. Currently, Android phones generally support NFC, Apple phones support Bluetooth 4.0 and others are a mix. The Android system is being presented here merely as a specific example.

This embodiment also comprises a communication engine (CE). The CE initializes all communication ports or sockets, and determines what type of protocol will be used on each specific port. It is important to note that communication ports can be wireless or wired. For contemplated embodiments, Bluetooth LE, WIFI, cellular and/or NFC may be used, but again any wireless protocol within the vehicle can be used.

A key function of the CE is to set a unique Bluetooth LE PIN to the OBDII device. Most, if not all, Bluetooth devices come set with a PIN of 1234 or 0000. The CE will use the vehicle ID number (VIN), IMEI number and the operating system version ID to calculate a unique four digit identifier. Both the VIN and IMEI (International Mobile Station Equipment Identity) numbers are unique identifiers associated to the vehicle and phone. The version of the operating system (OS) is expected to change. Given that a Bluetooth PIN is only four digits long an update of the OS will cause a new PIN to be generated at unknown intervals, thus adding another layer of security. The OS version number will be used to determine which digits of either the VIN or IMEI will be combined to create a unique PIN. This PIN will then be programmed back into the OBDII Bluetooth device. This capability will be completed during the parent phase of installation. The user will also be given the option of creating a PIN of their choosing.

The CE also is the portion of the application where the device receives all incoming text's while the vehicle is in motion. In the specific case of text messages, the application or device simply stores the message(s) so that they can be delivered to the default SMS application once the vehicle has stopped.

The CE is responsible for communicating with the OBDII Bluetooth device and converting the message/PID to key variables such as speed, transmission mode and any simple diagnostic information that can be shared with the user after the car is turned off.

The logical state engine (LSE) is the portion of the application that determines what state the application is in. There are various states possible, please reference the state diagram to understand how the application moves through the various states.

The LSE is the application call back for system events, OS events, UIE events and any error handing events that occur within the system. The LSE also sends potential violation events to PE to determine if a violation has occurred and what action to take.

The policy engine (PE) receives event notices from the logic state engine (LSE) or directly from the policy engine and returns policy compliance or violation data sets back to the LSE. The LSE sends requests to the policy engine to execute the specific policy.

The user interface engine (UIE) presents the user with a user interface that allows the user to identify the vehicle year, manufacture, user specific information, password for de-installation and certain user preferences. The UEI also presents the parent/administrator the options for determining the policies for the user in the specific vehicle. It will obviously ask the administrator when setting up multiple vehicles if they would like to repeat the policy from the previous vehicle.

Contemplated standards comprise:

SAE STANDARDS DOCUMENTS ON OBDII
J1962, J1850, J1978, J1979, J2012, J2178-1 THRU J2178-4, J2284-3, J2411,

SAE STANDARDS DOCUMENTS ON HD (HEAVY DUTY) OBD
J1939

ISO STANDARDS
ISO 9141, ISO 11898, ISO 14230, ISO 15031, ISO 15765

JOBD—JAPAN VERSION

ADR 79/01 & 79/02 AUSTRALIAN OBD STANDARD)

EOBD—EUROPEAN OBD

Thus, specific embodiments and methods of the vehicle operator/driver and wireless device synchronization have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A vehicle operator/driver and device synchronization application, comprising:
a two-way communication device,
a software application stored on and executed from the device, from a network or a combination thereof,
a vehicle communication component,
a velocity determination component, and
a driver identification component.

2. The vehicle operator/driver and device synchronization application of claim 1, further comprising a non-removal component.

3. The vehicle operator/driver and device synchronization application of claim 2, wherein the non-removal component comprises:
at least two log creation functions,
at least one communication system,
at least one dedicated settings function, and
at least one reboot function, restart function, reinstallation function or combination thereof.

4. The vehicle operator/driver and device synchronization application of claim 1, wherein the velocity component identifies the velocity of the car, the velocity of the phone or a combination thereof.

5. The vehicle operator/driver and device synchronization application of claim 1, wherein the driver identification component allows the operator or passenger to input information regarding the identification of the driver.

6. The vehicle operator/driver and device synchronization application of claim 5, wherein the driver identification component allows the operator or passenger to input information regarding the identification of the driver before the vehicle is actively operated, started, driven or a combination thereof.

7. The vehicle operator/driver and device synchronization application of claim 1, wherein the driver identification component automatically determines the identity of the operator or driver.

8. The vehicle operator/driver and device synchronization application of claim 7, wherein the driver identification component identifies the operator or driver before the vehicle is actively operated, started, driven or a combination thereof.

9. The vehicle operator/driver and device synchronization application of claim 1, further comprising at least one log creation function that identifies information, logs that information in a logical organization structure and makes that log available to an entity.

10. The vehicle operator/driver and device synchronization application of claim 9, wherein the at least two log creation function logs who has operated the vehicle, acceleration events, deceleration events, what devices are used when the vehicle is in motion, who is the owner of the vehicle or a combination thereof.

11. The vehicle operator/driver and device synchronization application of claim 1, further comprising a policy component.

12. The vehicle operator/driver and device synchronization application of claim 11, wherein the policy component connects and disconnects the operator/driver and the device from the application.

13. A vehicle operator/driver and device synchronization application, comprising:
a two-way communication device,
a software application stored on and executed from the device,
a vehicle communication component,
a velocity determination component,
a driver identification component, and
a password generation component.

14. The vehicle operator/driver and device synchronization application of claim 13, wherein the password generation component utilizes information from the vehicle, the device or a combination thereof to generate a PIN for the system.

15. The vehicle operator/driver and device synchronization application of claim 14, wherein the system password is unique.

16. The vehicle operator/driver and device synchronization application of claim 3, wherein the at least two log creation functions are used to determine if the application has been tampered with.

17. The vehicle operator/driver and device synchronization application of claim 16, wherein the at least two log creation functions further provides at least one piece of reporting information.

18. The vehicle operator/driver and device synchronization application of claim 17, wherein the at least one piece of reporting information comprises the date of the tampering, the time of the tampering or a combination thereof.
